(19) United States
(12) Patent Application Publication
(10) Pub. No.: US 2011/0274232 A1
(43) Pub. Date: Nov. 10, 2011

(54) ROBOT SYSTEM FOR LAYING A RAIL TRACK

(76) Inventor: Fredy Doll, Schwaigern (DE)

(21) Appl. No.: 13/138,202

(22) PCT Filed: Oct. 21, 2010
(86) PCT No.: PCT/EP2010/065892

§ 371 Date: Jul. 19, 2011

(30) Foreign Application Priority Data
Oct. 21, 2009 (DE) 10 2009 051 583.6

(51) Int. Cl. G21C 19/02; G21C 11/00; E01B 29/00; B25J 5/02; B61B 9/00

(52) U.S. Cl. 376/260; 104/2; 376/293

(57) ABSTRACT

The invention relates in particular to a robot system comprising a rail track and a robot, which is designed to be displaceable in a direction of movement, guided by the rail track. According to the invention, the rail track consists of a plurality of rail track segments disposed in the direction of movement, and the robot is designed to handle such rail track segments and to extend the rail track by attaching further rail track segments to a respective last rail track segment of the existing rail track. Furthermore, according to the invention, a tension member that is attached to the robot, in particular a tension cable, is provided, which runs along the rail track, wherein a winding device for receiving the tension member is provided in order to introduce a tractive force, preferably in the region of an end of the rail track. The invention is used in particular in order to make it possible to provide a rail track in an area that is difficult or impossible for humans to access and to recover a robot running thereon in the event of damage.

### FIELD OF APPLICATION AND PRIOR ART

The invention relates to a robot system comprising a rail track and a robot that is adapted to be guided by means of the rail track for movement in a direction of motion. The invention further relates to a nuclear power station comprising a robot of this type.

Generic robot systems are known in the prior art. They consist of a robot that comprises a slide by means of which it can move along the rail track. This robot comprises at least one tool that can be moved relatively to the slide by a robot arm that is movable about a plurality of rotation axes. The slide enables the robot to be used flexibly at a plurality of locations and/or to transport material between different locations.

The robot systems known in the prior art comprise rail tracks that are usually assembled manually before putting the robot system into operation. When the rail-bound robot is put into operation, it is placed on the rail track only after the latter has been assembled.

When dismounting nuclear power stations, it is particularly problematic to dismantle the nuclear reactor itself and additional components disposed in the containment of the nuclear power station, since the relevant work cannot be carried out by humans. The exposure to radiation is so high that, even in the containments of nuclear power stations that have not been in use for several years, there are no protective measures which suffice to enable humans to work for an extended period of time inside the containment. The dismantling of components disposed in the containment has therefore usually been carried out hitherto by remote-controlled equipment that can move on the floor of the containment by means of a travel drive provided for this purpose. It has been found that this method permits only very slow dismantling of the components inside the containment of the nuclear power station due to the lack of precision of such equipment.

The use of a rail-bound robot for the purpose of dismantling the components inside the containment has not been possible hitherto since the rail track could not be laid by humans due to the high exposure to radiation.

### OBJECT AND ITS ACHIEVEMENT

It is an object of the invention to develop a generic robot system to the effect that it can also be used in strongly contaminated areas and to provide a method of assisting dismantling of a nuclear power station with the aid of such a robot system.

According to the invention, the rail track comprises, for this purpose, a plurality of rail-track elements disposed in the direction of motion and the robot is configured to manipulate such rail-track elements and to lengthen the rail track by attaching an additional rail-track element to the last rail-track element of an existing rail track. Additionally, the robot is equipped with a traction member, more particularly a traction cable, secured to the robot and extending along the rail track, a winder for taking up the traction member being provided in the region of one end of the rail track for the purpose of applying a tractive force.

Thus, according to the invention, the rail track is of modular construction and the robot itself that is capable of moving on the rail track can lay the individual rail-track elements in the form of modules for lengthening said rail track. For this purpose, the robot comprises a traveling unit that is adapted to the rail track in such a way that the robot is guided by the traveling unit relatively to the rail track and can exert a driving force on the rail track for the purpose of moving the robot. Preferably, the robot further comprises a robot arm, by means of which a gripper and preferably additional tools can be flexibly moved relatively to the traveling unit. This gripper is configured to grasp, move, and deposit the rail-track elements.

According to the invention, a traction member that allows the robot to be pulled out of an inaccessible area in the event of damage is fastened to the robot. This feature is advantageous, since firstly there is no requirement for direct human intervention in the contaminated area for constructing the rail system and secondly the necessity of entry of a human to the contaminated area in the event of a mechanical breakdown of the robot is obviated.

Thus, if it is not possible to pull the robot out of the contaminated area during operation by means of the drive motor provided for normal operation, the robot is pulled out by means of a winder that is preferably disposed outside the contaminated area and can therefore be manipulated by an operator without the risk of exposure to radiation. The winder is characterized in that it can apply a tractive force to the traction member. Preferably, this tractive force is applied by the winder by means of a winding drum on which the preferably flexible traction member is taken up.

Preferably, the robot is configured to be movable on the rail track by means of a driving wheel that is attached to the robot and that cooperates with the rail track and is driven by means of the drive motor, means being provided for decoupling the drive motor from the rail track. Such decoupling means enable the robot to assume a state in which the process of retrieving the robot can be carried out by means of the traction member without this process being hindered by a possibly defective drive motor. In the simplest case, such decoupling of the drive motor from the rail track can be achieved by means of a clutch.

Preferably, the means for decoupling the drive motor from the rail track are configured such that they can also be operated in the case of a breakdown of the electrical system of the robot by means of an externally accessible operating handle on the robot that can be actuated manually. Such a design enables the drive motor to be decoupled from the rail track in case of an emergency by a second robot that is guided on the same or a different rail track.

Preferably, the robot system comprises a control device for activating the robot, which control device is configured to automatically control the removal of additional rail-track elements from a storage area, to transport these rail-track elements to the end of the rail track and/or to position the rail-track elements at the end of the rail track. For this purpose, the robot can comprise sensors that allow the robot to detect the position of the rail-track elements at the storage area and/or the desired position of a rail-track element at the end of the rail track already laid.

It is particularly advantageous when the robot is configured to fix the new rail-track elements to an underlying surface and/or to the last rail-track element of an existing rail track. Thus it is feasible, for example, for the robot to be equipped so as to automatically weld the rail-track elements to each other. It is more advantageous, however, when the rail-track elements themselves have coupling means immovably attached to the rail-track elements to bring about positive coupling when a rail-rack element is positioned for attachment to the last rail-track element of an existing rail track, which positive coupling prevents the rail-track elements from coming apart. Preferably, such coupling means are configured such that a vertical downward movement of a new rail-track element will achieve positive coupling of the rail-track elements in the direction of motion of the robot. This can be effected, for example, by means of a dovetail joint or the like comprising an appropriate tongue at one end of the rail-track element and a complementary groove at the other end thereof, which can be accessed from above and/or from below, each rail-track element preferably comprising complementary coupling means at each of the two opposing ends thereof. One major advantage of such coupling means is that the robot does not require any tools other than the gripper in order to establish coupling of the rail-track elements. Alternatively or additionally, provision can be made for the robot to be configured so as to positively connect a rail-track element to be attached to the last rail-track element of an already existing rail track and/or to the underlying surface by means of a separate connecting link. Such a separate connecting link can be provided, for example, in the form of a retaining bolt or a retaining screw that is inserted or screwed in by the robot after the new rail-track element has been correctly positioned. The robot optionally has a tool that is provided for this purpose. For fixing a new rail-track element to the underlying surface, the robot is preferably configured to prepare the underlying surface accordingly, more particularly to bore holes in the underlying surface and optionally to insert plugs into said holes.

These actions required when fixing a new rail-track element to the existing rail track are preferably carried out by the robot automatically and without the assistance of a human operator.

Provision is made, in a development of the invention, for at least one of the rail-track elements to comprise at least one surface adapted to rest on the underlying surface at a variable distance from the top surface of the rail-track element. The robot is preferably configured so as to be capable of varying this distance automatically.

Preferably, a plurality of separately adjustable surfaces adapted to rest on the underlying surface is provided on at least one rail-track element and more preferably on all rail-track elements. These adjustable surfaces allow the rail-track elements to be adjusted in the case of an uneven underlying surface in such a way that an even and horizontal travel path is formed on the rail track. The simplest way of achieving a variable distance between said surface and the top surface of the rail-track element is to use replaceable spacers. Preferably, this distance is infinitely adjustable, particularly by means of a spacer that can be displaced by means of a screw thread. Moreover, the adjustability of the spacer by means of a screw thread is particularly well-suited to ensure that the robot itself can adjust the distance between the said surface and the top surface of the rail-track element. Preferably, the robot has a tool which can be attached to the robot arm and by means of which the adjustment of said surface adapted to rest on said underlying surface is possible. The robot can alternate between the gripper and this tool in order to adapt the rail-track element to the underlying surface in question before laying the same.

It is particularly advantageous when a toothed rack is provided on the rail track and the drive wheel disposed on the robot is in the form of a pinion drive gear that meshes with the toothed rack, the pinion drive gear being displaceable relatively to the robot in order to be disengaged from the toothed rack.

The invention also relates to a nuclear power station comprising a containment, in the interior of which there is radioactive contamination, and an exterior area that is shielded against radiation from the containment, an access opening being provided between the exterior area and the interior of the containment. Such an access opening is usually provided in the wall of the containment when dismantling the nuclear power station, in order that the components located in the containment can be removed. According to the invention, the nuclear power station is provided with a robot system of the type described above, the rail track of which extends from the exterior area through the access opening into the interior of the containment.

Particularly when dismantling such a nuclear power station, it is advantageous to use the robot system described above, since this robot system is self-constructing, starting from the exterior area and extending through the access opening, after which it can be used to disassemble the components inside the containment and/or to transport the same out of the containment.

For the purposes of this invention, the term “containment” refers to that region of a nuclear power station which is shielded off from the environment and is contaminated with radiation and in which the nuclear reactor is disposed. The use of the robot system described above as proposed by the invention is not restricted to special types of nuclear power stations, but can be used in all types.

In large containments, it may be advantageous to use two robot systems of the invention that have access to the containment through separate access openings and run on separate rail tracks.

Preferably, the exterior area is delimited by a sluice chamber. A sluice gate is provided in the region of the access opening between this sluice chamber and the interior of the containment. Preferably, this sluice gate is designed so as to be closable when the rail track has been laid, more particularly by constructing the sluice gate so as to have a recess matching the shape of the cross-section of the rail track.

According to the method for operating a robot of the invention, the robot is used for assembling a rail track for a rail-bound robot, the rail track comprising a plurality of rail-track elements. The rail-mounted robot, starting from a state in which it is placed on an already laid portion of the rail track, grasps a rail-track element, which is intended to be attached to the already laid portion of the rail track, from a storage area, moves it to the end of the laid portion of the rail track, and deposits this new rail-track element for the rail track such that it is aligned with the laid portion of the rail track. In this way, the robot lengthens the travel path along which it is movable. These steps are repeated with additional rail-track elements until the rail track has reached its target length.

It is particularly advantageous when, during or following deposition of this additional rail-track element, the robot establishes a positive connection between a new rail-track element on the one hand and the end of the previously laid rail-track and/or the underlying surface on the other hand. Making such a positive connection when depositing the additional rail-track element can be realized by way of the shape of the rail-track elements described above comprising appropriate coupling means. Alternatively or additionally, additional connecting means such as screws or bolts can be provided, by means of which the newly laid rail-track element is fixed to the underlying surface or to the previously laid rail element. For manipulating these connecting means, the robot can preferably replace a gripper provided for manipulating the rail-track elements with a tool that can be coupled to the robot arm and that is suitable for use on said connecting means.

Furthermore, it is particularly advantageous when the robot carries out an adjustment of each rail-track element in terms of the distance thereof from the underlying surface by adjusting at least one of the surfaces adapted to rest on said underlying surface. This adjustment can be carried out, for example, by the robot arm, which may have been previously equipped, by the robot, with a suitable tool from a tool magazine. Preferably, the adjustment of the rail-track element is carried out before the robot grasps the respective rail-track element at the storage area. Likewise or additionally, the rail-track elements can be provided with specifically selected spacers having a surface adapted to rest on said underlying surface before they are grasped by the robot, whilst this step can alternatively be carried out manually in the exterior area shielded from radiation.

Preferably, the relevant adjustment of the surface adapted to rest on said underlying surface is carried out on the basis of a 3D model that has been stored in a memory in the robot and that geometrically depicts the region in which the rail track is to be laid.

Preferably, the robot of the invention is used in a process for dismantling a nuclear power station. In this process, a rail track extending from an exterior area to the interior of a containment of the nuclear power station is laid according to the procedure described above, for dismantling radioactively contaminated components of the nuclear power station disposed inside the containment.

It is particularly advantageous when the rail-mounted robot used for laying the rail-track elements is also used, following the assembly of the rail track, for dismounting components of the nuclear power station disposed inside the containment and/or for transporting the dismounted components from the containment to the exterior area. Thus the robot performs a double function. Firstly, it lays its own rail track to be subsequently capable of moving along this rail track such that the components of the nuclear power station can be dismounted. It is also particularly advantageous when the components are dismounted and the dismounted components are transported jointly by two robots that are preferably movable on the same rail track. At least one of these robots is also used beforehand for assembling the rail track.

Furthermore, it is particularly advantageous when the interior of the containment is scanned by means of a 3D scanning process, more particularly before and/or during the assembly of the rail track. Such a 3D scan can be realized, for example, by means of an appropriate laser scanning device that scans the space inside the containment from a fixed position and produces a 3D model thereof. The data thus acquired can be used to appropriately adjust the distance of rail-track elements from the underlying surface. It is particularly advantageous when this scanning process is carried out by means of a measuring apparatus that can likewise be manipulated by the robot and can be inserted into the containment while attached to a lance or the robot arm.

### BRIEF DESCRIPTION OF THE DRAWINGS

Additional aspects and advantages of the invention are revealed in the claims and the following description of an exemplary embodiment of the invention, which is explained below with reference to the diagrammatic figures, in which:

FIG. 1 shows a robot system of the invention in a starting position before the assembly of the rail track,

FIG. 1a shows a rail-track element of the robot system defined in claim 1,

FIG. 1b shows a rail-mounted robot of the robot system shown in FIG. 1,

FIGS. 2a to 2g illustrate the assembly of the rail track of the robot system of the invention,

FIG. 3 shows the robot system in the fully assembled state of the rail track, and

FIG. 4 illustrates a dismounting process carried out using the robot system of the invention.

### DETAILED DESCRIPTION OF THE EXEMPLARY EMBODIMENT

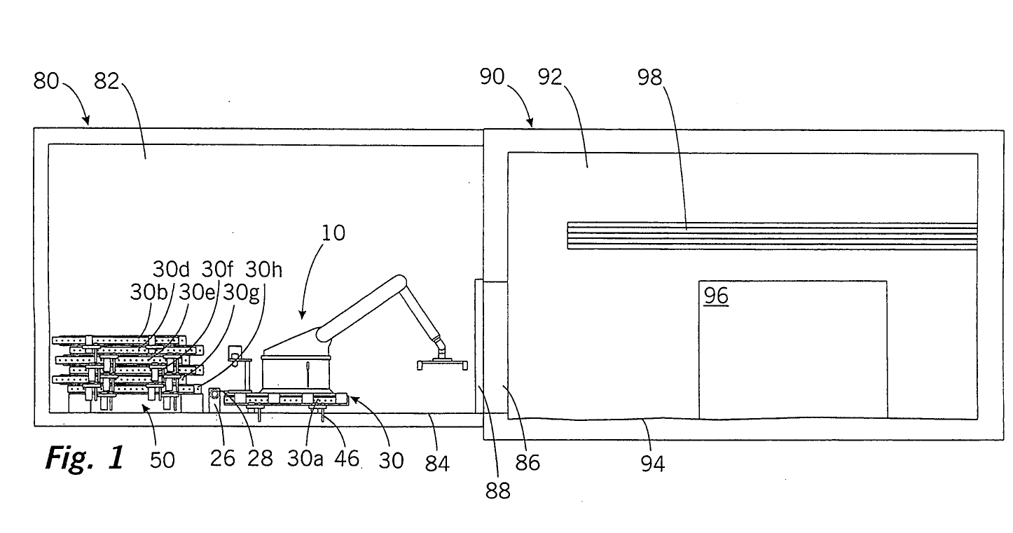

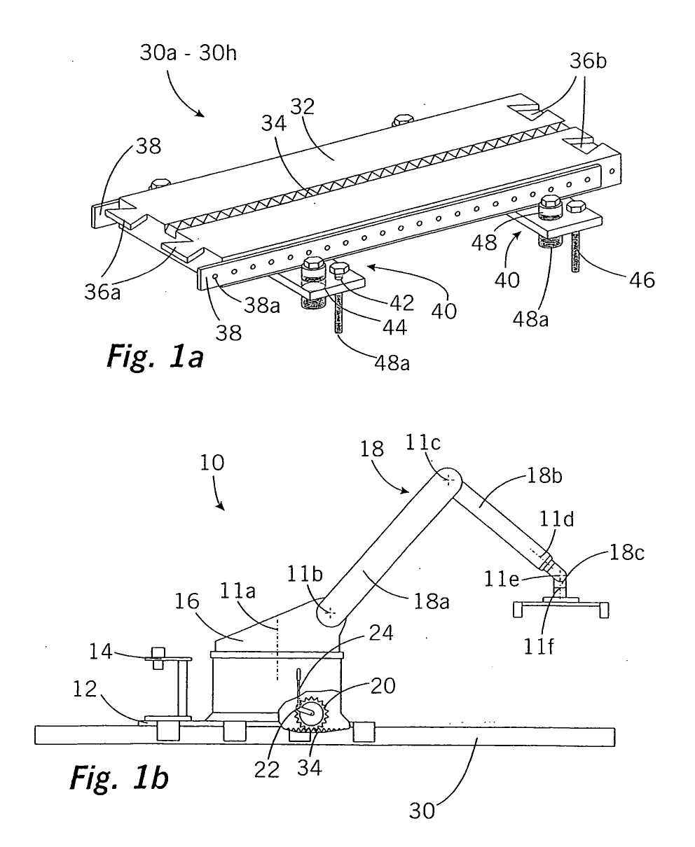

FIG. 1 is a diagrammatic view of a robot system of the invention in a starting state thereof. The robot system comprises a rail-mounted robot 10 that is adapted to be moved on a rail track 30. In the starting position shown in FIG. 1, the rail track 30 comprises only one single rail-track element 30a which has been previously laid and fixed to an underlying surface 84 by means of screws 46.

The rail-mounted robot 10 and the rail track 30 initially comprising only the rail-track element 30a are located in the interior 82 of a sluice chamber 80 that is positioned so as to adjoin a containment 90 of a CANDU nuclear power station. This containment 90, which is to be dismantled by means of the robot system 10, 30 in accordance with regulations, comprises a nuclear reactor 96 and a plurality of pipes represented by the pipe bundle 98 in FIG. 1. There is a high level of radioactive radiation inside the containment 90 that makes it impossible for humans to directly work therein for the purpose of dismounting the reactor 96 and the pipe bundle 98. The interior 82 of the sluice chamber 80 communicates with the interior 92 of the containment 90 by way of an access opening 86 previously formed in the wall of the containment 90 for dismounting purposes. This access opening 86 can be closed and opened by means of a sluice gate 88 that can be moved in the vertical direction for this purpose in a manner not illustrated in detail in the figures.

The robot system 10, 30 is configured to automatically lengthen the rail track 30 into the interior 92 of the containment 90 so that the strongly contaminated components 96, 98 can then be dismounted in the containment 90 by means of robots. Additional rail-track elements 30b to 30h, which are stacked in a storage area 50, are provided for this purpose, apart from the rail-track element 30a that has already been laid and fixed to the underlying surface.

The construction of the individual rail-track elements 30a to 30h is shown in FIG. 1a. The rail-track elements 30a to 30h, which are identically constructed with a length of preferably from 1 m to 1.50 m, each comprise a main body 32, the top surface of which is broken along its main direction of extension by a toothed rack 34. At the two opposing ends of the rail-track element as regarded in the main direction of extension thereof, dovetail tongues 36a are provided at one end and complementary grooves 36b at the other end. Connector strips 38 comprising bores 38a are provided on the sides of the main body 32. Two radial arms 40, each comprising a bore 42 for a locating bolt 46 and a screw-threaded hole 44 for a leveling screw 48, are attached to each side of the main body 32 for adjusting the height of the rail-track element and fixing the same to the underlying surface. The leveling screw 48 is provided with a hexagonal head that makes it possible to adjust the leveling screw 48 and thus its undersurface 48a bearing against the underlying surface. The total of four leveling screws 48 on each rail-track element makes it possible to flexibly adapt each rail-track element to the underlying surface, even when the latter is extremely uneven.

FIG. 1b shows the rail-mounted robot 10 in detail. It comprises a traveling unit 12, which can move on the rail track, and on the left-hand side of which there is provided a tool magazine 14. A rotary unit 16 supporting a robot arm 18 comprising arm elements 18a, 18b, 18c is provided on the traveling unit 12. The distal arm element 18c is in the form of a tool holder for the accommodation of a tool. In the state shown in FIG. 1b, a gripper 60 is attached to the tool holder 18c. The tool can be moved flexibly due to the ability of the robot arm 18 or parts thereof to rotate about the rotation axes 11a to 11f realized by the use of electric, hydraulic or pneumatic means.

The rail-mounted robot 10 is driven by means of an electric motor (not shown) that acts upon a pinion drive gear 20. The pinion drive gear meshes with the toothed rack 34 of the rail track 30 in the state shown in FIG. 1b. The electric motor (not shown) and the pinion drive gear 20 can be pivoted upwardly about the pivot axis 22 by means of a lever 24 mounted on the traveling unit 12 and accessible externally such that the pinion drive gear 20 can disengage from the toothed rack 34. The purpose of this measure is explained below.

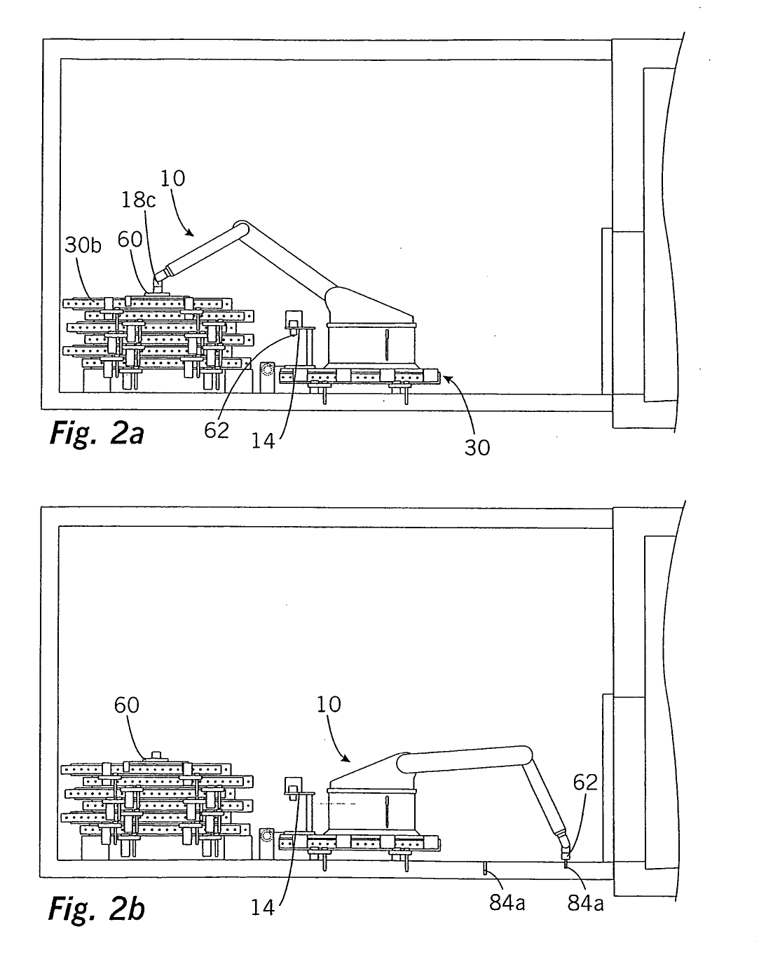

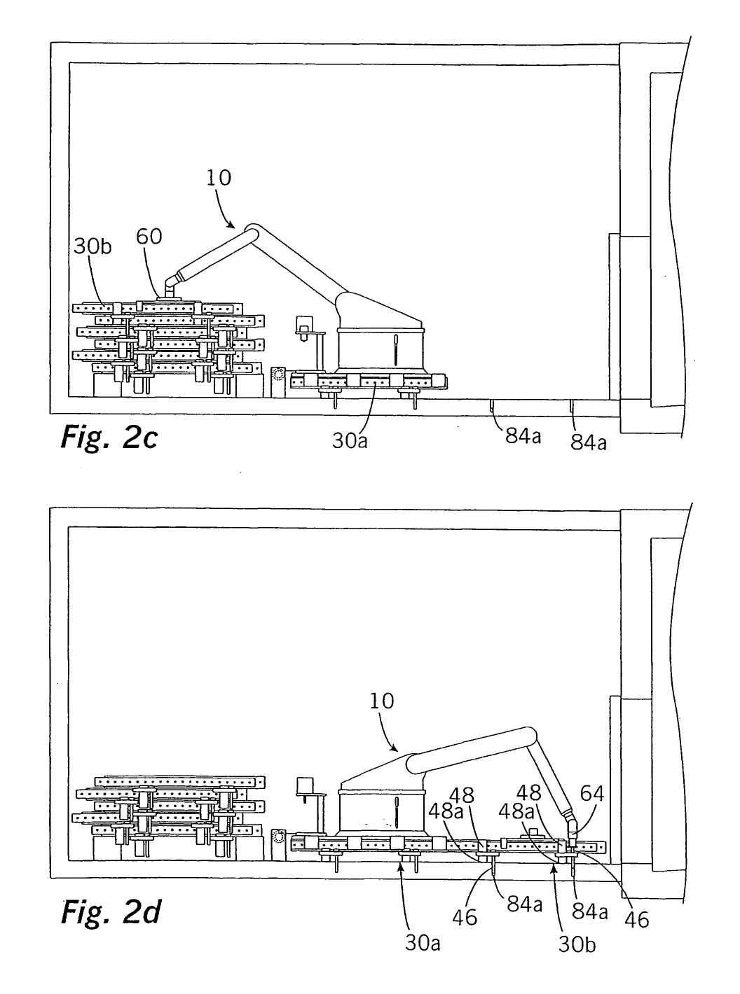

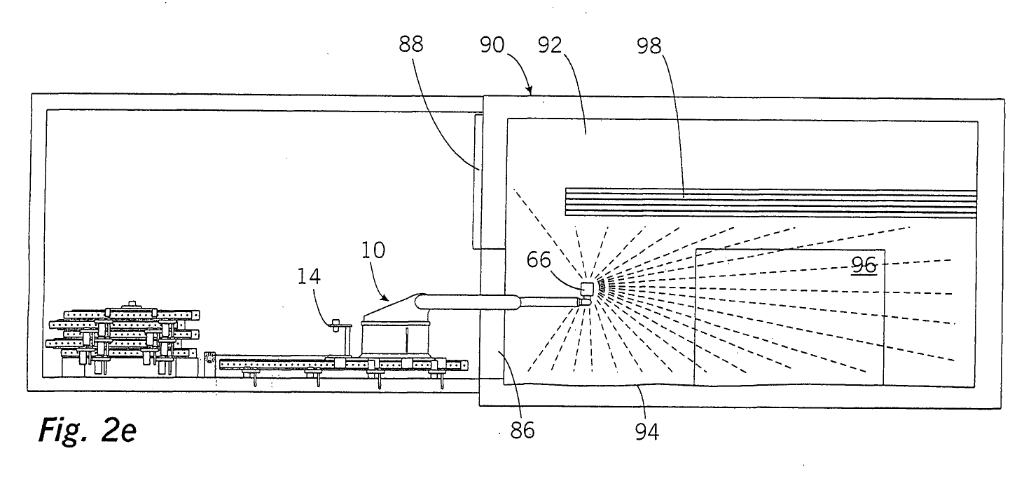

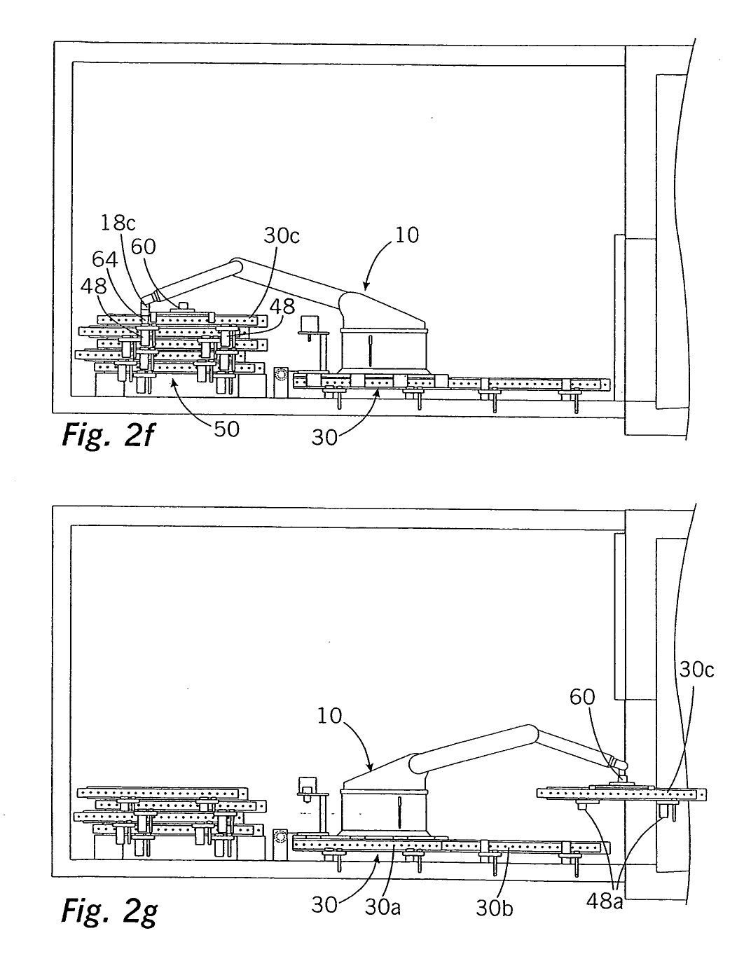

The mode of operation of the robot system 10, 30 for assembling the rail track 30 will now be explained with reference to FIGS. 2a to 2g.

From the starting position shown in FIG. 1, the rail track 30 will first be supplemented by the rail-track element 30b. For this purpose, the robot 10 first grasps the rail-track element 30b stacked in the storage area 50 by means of the rail-element gripper 60 coupled to the tool holder in the initial state. The gripper 60 is then decoupled from the tool holder 18c without lifting the rail-track element 30b, and a drilling tool 62 located in the tool magazine 14 is coupled to the tool holder in place of the gripper. As shown in FIG. 2b, the robot 10 bores holes 84a in the underlying surface 84 of the sluice chamber 80 in a preliminary step by means of this drilling tool 62.

The robot 10 will then recouple the rail-element gripper 60 to the tool holder, as shown in FIG. 2c, and will move the rail-track element 30b to its intended location at the right-hand end of the rail-track element 30a that has already been laid. When the rail-track element is moved vertically downwardly, the dovetail tongues 36a (not shown in FIGS. 2a to 2g) of the rail-track element 30b automatically engage in the complementary grooves 36b of the rail-track element 30a so that positive coupling is already achieved when depositing the rail-track elements. The leveling screws 48 of the rail-track element 30b have already been adjusted correctly in advance so that no more adjustment is required at this point. But it is also possible for the leveling screws 48 to be adjusted by the robot itself, as explained below with reference to the rail-track element 30c.

For fixing the newly mounted rail-track element 30b, the robot 10 disconnects the rail-element gripper 60 after depositing the rail-track element 30b in order to remove a screwing tool 64 from the tool magazine 14, which screwing tool 64 is used, as shown in FIG. 2d, to drive the screws 46 into the previously produced holes 84a.

The rail-track elements 30a to 30f can be additionally connected by means of connector strips 38 and additional screws to be inserted therein. This step need not be explained here in detail.

Before the robot 10 continues with the construction of the rail track 30, the interior 92 of the containment 90 will first be scanned in a subsequent step. For this purpose, the robot will first couple a 3D scanner 66 from the tool magazine 14 to the tool holder, which will then, after opening the sluice gate 88, move this 3D scanner 66 into the interior 92 of the containment 90, where it will carry out a 3D scan, as shown in FIG. 2e. In particular, the floor 94 of the containment 90 is scanned by means of this 3D scanner in order to obtain the height information required for laying the additional rail-track elements 30c to 30f.

When the 3D scan is complete, the construction of the rail track 30 will be continued, for which purpose the robot 10 will first automatically adjust the leveling screws 48 according to the previously determined height information of the floor 94 of the containment 90 before removing each rail-track element 30c to 30f from the storage area 50. This step is illustrated in FIG. 2f. When the appropriate adjustment has been accomplished, the corresponding rail-track element 30b to 30f is transported up to the end of the rail track 30 that has already been laid and deposited here by means of the rail-element gripper 60 so that positive coupling is again achieved between the rail-track elements by means of the dovetail tongues and grooves 36a, 36b. As described with reference to FIG. 2b, holes 94a will first be bored for each rail-track element in the floor 94 of the containment 90.

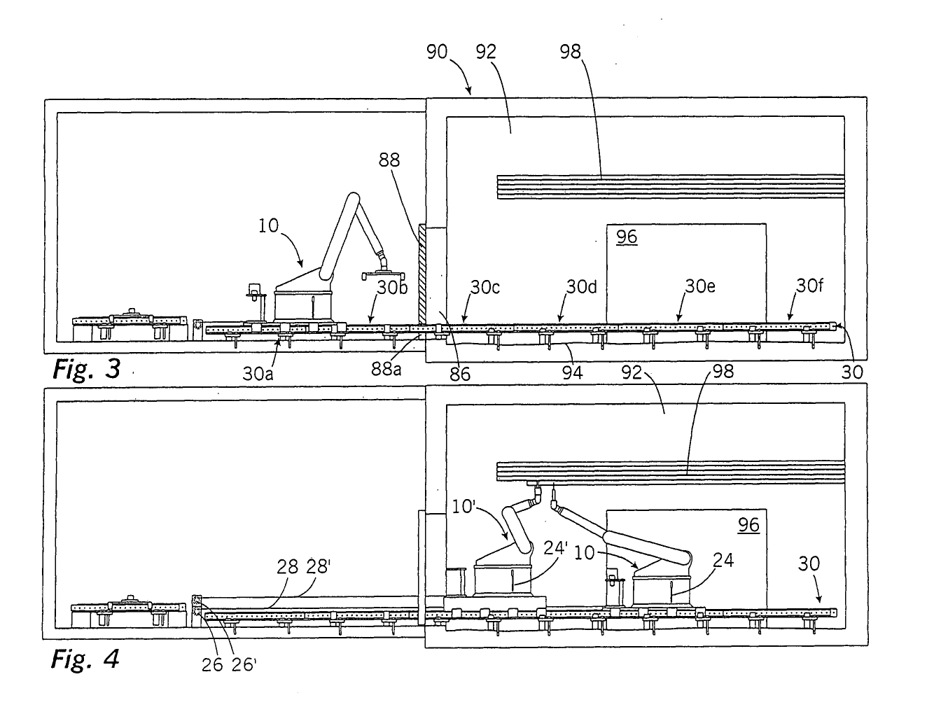

FIG. 3 shows the robot system following completion of the rail track 30. It is evident that the rail track 30 can be laid far into the interior 92 of the containment 90 by means of the robot 10 without endangering human life so that the dismounting of components can begin inside the containment 90 on the basis of the fully assembled state of the rail track.

In FIG. 3, the sluice gate 88 is shown in cross section. It can be seen that the sluice gate comprises a recess 88a at its bottom edge. The shape of this recess 88a matches the cross-section of the rail track 30 so that the amount of radiation escaping from the containment when the sluice gate 88 is closed is very slight.

FIG. 4 shows the operation of the robot 10 and of a second robot 10′ when dismounting the pipe bundle 98. For this purpose, both robots 10, 10′ use the rail track 30 as the travel path. Together, they can rapidly and efficiently disassemble and dismantle the components 96, 98 to be dismounted in the containment 90 and transport these components out of the containment 90 through the access opening 86 so that said components can be removed for decontamination.

Both robots 10, 10′ have traction cables 28, 28′ that allow the robots 10, 10′ to be pulled out of the interior 92 of the containment 90 by means of electrically driven winches 26, 26′, should there be a breakdown of the drive motor of any one of the robots 10, 10′. For decoupling the respective drive motor when pulling out the defective robot 10, 10′ by means of any one of the winches 26, 26′, the respective lever 24, 24′ of the robot 10, 10′ described above can be externally actuated mechanically by the other robot. As a result, it is possible to retrieve a damaged robot from the containment, even though it would not have been possible to return said robot to the sluice chamber 80 as long as the pinion drive gear 20 meshed with the toothed rack 34 of the rail track 30.

1. A robot system comprising
a rail track (30) and
a robot (10) that is adapted to be guided by said rail track (30) for movement in a direction of motion,
wherein
said rail track (30) consists of a plurality of rail-track elements (30a to 30f) arranged in said direction of motion
said robot (10) is adapted for manipulating such rail-track elements (30b to 30f) and for lengthening said rail track (30) by attaching further rail-track elements (30b to 30f) to the last rail-track element of an existing rail track (30) and
a traction member (28), more particularly a traction cable (28), is provided which is secured to said robot (10) and extends along said rail track (30) and, for the purpose of creating a tractive force, a winding device (26) is provided, preferably in the area of one end of said rail track (30), for taking up said traction member (28).

2. The robot system as defined in claim 1,
wherein said robot (10) is adapted to fix new rail-track elements (30b to 30f) to an underlying surface (84, 94) and/or to the last rail-track element (30a to 30) of an existing rail track (30), and to this end
the rail-track elements (30a to 30f) preferably have immovably mounted coupling means (36a, 36b) which create a positive coupling when a new rail-track element (30b to 30f) is positioned at the last rail-track element of an existing rail track (30) and/or
said robot is adapted to create a positive connection by means of a separate connecting member (46) between a new rail-track element (30b to 30f) and the last rail-track element of an existing railway track (30) and/or between said new rail-track element (30b to 30f) and said underlying surface (84, 94).

3. The robot system as defined in claim 1, wherein at least one of the rail-track elements (30a to 30f) has at least one surface (48a) adapted to rest on said underlying surface at a variable distance from the top surface of said rail-track element (30a to 30f), the robot (10) being preferably adapted to vary said distance.

4. The robot system as defined in claim 1, wherein said robot (10) is adapted to be movable along said rail track (30) by means of a driving wheel (20) that cooperates with said rail track (30) and is driven by a drive motor and means (22, 24) are provided for decoupling said drive motor from said rail track (30).

5. The robot system as defined in claim 4, wherein a toothed rack (34) is provided on said rail track (30) and said driving wheel (20) on said robot (10) is in the form of a gearwheel (20) which gearwheel (20) can be shifted relatively to said robot (10) for disengagement from said toothed rack (30).

6. A nuclear power station comprising
a containment (90), in the interior (92) of which radioactive contamination prevails,
an exterior area (82) that is radiation-shielded relatively to said containment (90), and
an access opening (86) being provided between said exterior area (82) and the interior (92) of said containment (90),
wherein at least one robot system as defined in claim 1, is provided, wherein the rail track (30) of said robot system extends from said exterior area (82) through said access opening (88) to the interior (92) of said containment (90).

7. The nuclear power station as defined in claim 6, wherein that said exterior area (82) is delimited by a sluice chamber (82) and is provided with a sluice gate (88) between said sluice chamber (82) and the interior (92) of said containment (90), which sluice gate (88) preferably has a recess (88a) for said rail track (30).

8. The use of a robot system as defined in claim 1 in a nuclear power station, in which said rail track (30) extends from an exterior area (82) through an access opening (86) to the interior (92) of a containment (90).

9. The use as defined in claim 8, wherein said robot system is used during dismantling of the nuclear power station.
